(19) United States
(12) Patent Application Publication
(10) Pub. No.: US 2014/0338845 A1
(43) Pub. Date: Nov. 20, 2014

(54) Slide-Glide Privacy Blind Barrier System

(71) Applicant: Cordell E. Ebeling, Isanti, MN (US)

(72) Inventor: Cordell E. Ebeling, Isanti, MN (US)

(21) Appl. No.: 14/211,017

(22) Filed: Mar. 14, 2014

Related U.S. Application Data
(60) Provisional application No. 61/783,519, filed on Mar. 14, 2013.

(51) Int. Cl. E04H 17/16; E05D 15/06

(52) U.S. Cl. CPC E04H 17/16; E05D 15/0621
USPC 160/214

(57) ABSTRACT

A convertible slide-glide panel privacy (or blind barrier section) system is provided for deck railings or fences. The system may consist of identical panel sections. A first panel section may consist of a stationary panel. Additional identical panel sections may be in an opposite facing orientation with respect to the first panel section and may be configured to slide in-between the most outer stationary structural supports (i.e., an upper railing, a lower railing and posts) of a deck railing or fence in order to either cover or open an existing space or gap between stationary balusters. The stationary panel may be attached directly under an upper railing and attached slide pieces. The sliding path of the additional panel sections may be linear or curvilinear. The sliding panel sections in the system may be constructed from a combination of or individually from composites, wood, metals, glass, lattice, PVC and transparent thermoplastics.

### CROSS-REFERENCE TO RELATED APPLICATION(S)

This application claims priority to U.S. Ser. No. 61/783,519, filed on Mar. 14, 2013, titled SLIDE-GLIDE PRIVACY BLIND BARRIER SYSTEM, the disclosure of which is hereby incorporated by reference in its entirety.

### BACKGROUND

The home improvement industry has seen significant growth in the last decade and is projected to continue to grow in the future. For example, in a Jan. 14, 2011 report from Harvard University on the home improvement industry it is estimated that in 2005 alone, consumers spent over a quarter of a trillion dollars on home improvement projects, and that this number has been growing at a rate of about 7% per year. As a result, manufacturers and retailers spend significant effort in trying to differentiate their products from the competition.

One commonly undertaken home improvement project involves adding fences, railings, outdoor-rooms and similar barrier structures (e.g., outdoor kitchens) to homes and landscaping. Railings and fences are often added for aesthetic and practical reasons, such as to add interest to landscaping or to provide a privacy barrier and block weather elements, such as wind. In other applications, railings and fences may be practical or mandatory. For example, a raised deck (i.e., above two feet off of the ground) will require railings to comply with higher standard building safety codes. Some codes require at least 200 lb lateral load. Composite decking is commonly used as deck flowing or railings, but is not rigid enough to meet the code requirement if the railings has a longer height.

Standard deck railings and fences are typically constructed using a series of posts anchored to the ground as structural supports, decking or flooring structures and the outer walls of permanent building structures (also used as structural supports). The posts are connected via generally rectangular planar sections that provide a containment function, such as preventing the passage of people or animals, and “view blockage” from different perspectives. In many fencing and railing systems, these sections are formed by top and bottom vertical railings that are tied together by a plurality of vertical members (sometimes referred to as balusters) which form open sections in a deck railing or fence barrier. In other arrangements, the top and bottom railings are tied together (or integral with) a solid sheet of material, such as mesh, glass, metal, wood, composites, or lattice configurations. Sections that form a permanent containment barrier structure are only offered in two standard modes, open and solid sections. In modes offering open sections, there is a multitude of secondary add-on privacy screening available. In addition, there are advantages and disadvantages associated with solid fencing/railing sections and open sections that use balusters. For example, the solid sections can block wind and prevent the passage of very small items and can offer privacy from neighbors or onlookers looking in from an outside perspective of the containment barrier structure. However, blocking the view of what is on the outer side or the inner side of a barrier fence or railing can sometimes be a disadvantage. An open section provides a view through the railing, with the resulting loss of privacy. Oftentimes, a user may desire the privacy of a solid section during some conditions and also, under other conditions, desire the outward-looking view provided by open sections. Thus, there is a need for a fence or railing that selectably offers consumers the convenience of combining both open and solid closed barrier sections and that offers the advantages of personal preferences to convert between these structure sections depending on current use conditions and that will also meet various safety code standards (e.g., International Code Council (ICC), American Fence Association, and U.S. Department of Labor and Industry Construction Codes and Licensing Division standards) such as providing 200 pounds of lateral pressure. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide a convertible slide-glide panel privacy system (or blind barrier section system, hereinafter “the system”) for deck railings or fences. The system may consist of two or more identical panel sections. A first panel section may consist of a stationary panel. A second (or more) of the identical panel sections may be in an opposite facing orientation with respect to the first panel section and may be configured to slide in between the most outer stationary structural supports (i.e., an upper railing, a lower railing and posts) of a deck railing or fence in order to either cover or open an existing space or gap between stationary balusters. The stationary panel may be attached directly under the top railing and attached slide pieces. The sliding path of the second (or more) panel sections may be either linear or curvilinear. The sliding panel sections in the system may be constructed from a combination of or individually from the following materials: composites, wood, metals, glass, lattice, PVC and transparent thermoplastics such as Polymethyl methacrylate (“PMMA”), also known as PLEXIGLASS. The system may be either manually or automatically operated. These and other features and advantages will be apparent from a reading of the following detailed description and a review of the associated drawings. It is to be understood that both the foregoing general description and the following detailed description are illustrative only and are not restrictive of the invention as claimed.

Another aspect is a slide-glide panel privacy system for deck railings and fences comprising: a first stationary panel section comprising a first plurality of balusters; one or more sliding panel sections positioned in an opposite facing orientation with respect to the first panel section, the one or more sliding panel sections comprising a second plurality of balusters; an upper railing attached to the first and the one or more sliding panel sections; a lower railing attached to the first and the one or more sliding panel sections; at least one post attached to the upper and lower railings; and a plurality of slide pieces integrally attached to the second plurality of balusters, the plurality of slide pieces facilitating the movement of the one or more sliding panel sections along a sliding path such that the one or more sliding panel sections cover or open an existing space between the first plurality of balusters.

A further aspect is a blind barrier section system for a deck railing comprising: a first stationary panel section comprising a first plurality of balusters; a plurality of sliding panel sections positioned in an opposite facing orientation with respect to the first panel section, each of the plurality of sliding panel sections comprising a second plurality of balusters; an upper railing attached to the first and the plurality of sliding panel sections; a lower railing attached to the first and the plurality of sliding panel sections; a plurality of posts attached to the upper and lower railings; and a plurality of slide pieces integrally attached to the second plurality of balusters, the plurality of slide pieces facilitating the movement of the plurality of sliding panel sections along a sliding path such that the plurality of sliding panel sections cover or open existing gaps between the first plurality of balusters.

### BRIEF DESCRIPTION OF THE DRAWINGS

FIG. 1A is a perspective view of a deck incorporating a slide-glide panel privacy system, in accordance with an embodiment;

FIG. 1B is a partially exploded view of a deck railing incorporating a slide-glide panel privacy system, in accordance with an embodiment;

FIG. 2A is a top view of a slide-glide panel privacy system in a closed orientation, in accordance with an embodiment;

FIG. 2B is a front view of a slide-glide panel privacy system in a closed orientation, in accordance with an embodiment;

FIG. 3A is a top view of a slide-glide panel privacy system in an open orientation, in accordance with an embodiment;

FIG. 3B is a front view of a slide-glide panel privacy system in an open orientation, in accordance with an embodiment;

FIG. 4A is an exploded view of illustrative components utilized in a mode of operation of the slide-glide panel privacy system, in accordance with an embodiment;

FIG. 4B is an exploded view of a bottom magnet configuration for the system of FIG. 4A, in accordance with an embodiment;

FIG. 5 is a top view of a slide-glide panel privacy system in an open orientation, in accordance with an alternative embodiment;

FIG. 6 is a top view of a slide-glide panel privacy blind system in a closed orientation, in accordance with an alternative embodiment;

FIG. 7A is an exploded view of a bar safety slip mechanism which may be utilized in a slide-glide panel privacy system, in accordance with an embodiment;

FIG. 7B is an exploded view of a cylindrical safety slip mechanism which may be utilized in a slide-glide panel privacy system, in accordance with an embodiment;

FIG. 7C is an exploded view of a cylindrical safety slip mechanism which may be utilized in a slide-glide panel privacy system, in accordance with another embodiment; and

FIG. 8 is a perspective view of lateral reinforced inserts for balusters utilized in a slide-glide panel privacy system, in accordance with an embodiment.

FIG. 9 is an exploded view of a further example cylindrical safety slip mechanism.

FIG. 10 is a side cross-sectional view of the cylindrical safety slip mechanism 100 of FIG. 9.

FIG. 11 illustrates an example drive train assembly utilizing the cylindrical safety slip mechanism of FIG. 7B, 7C, or 9.

### DETAILED DESCRIPTION

Embodiments provide a convertible slide-glide panel privacy system (or blind barrier section system, hereinafter “the system”) for deck railings or fences. The system may consist of two or more identical panel sections. A first panel section may consist of a stationary panel. A second (or more) of the identical panel sections may be in an opposite facing orientation with respect to the first panel section and may be configured to slide in between the most outer stationary structural supports (i.e., an upper railing, a lower railing and posts) of a deck railing or fence in order to either cover or open an existing space or gap between stationary balusters. The stationary panel may be attached directly under the top railing and attached slide pieces. The sliding path of the second (or more) panel sections may be either linear or curvilinear. The sliding panel sections in the system may be constructed from a combination of or individually from the following materials: composites, wood, metals, glass, lattice, PVC and transparent thermoplastics such as Polymethyl methacrylate (“PMMA”), also known as PLEXIGLASS. The system may be either manually or automatically operated.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

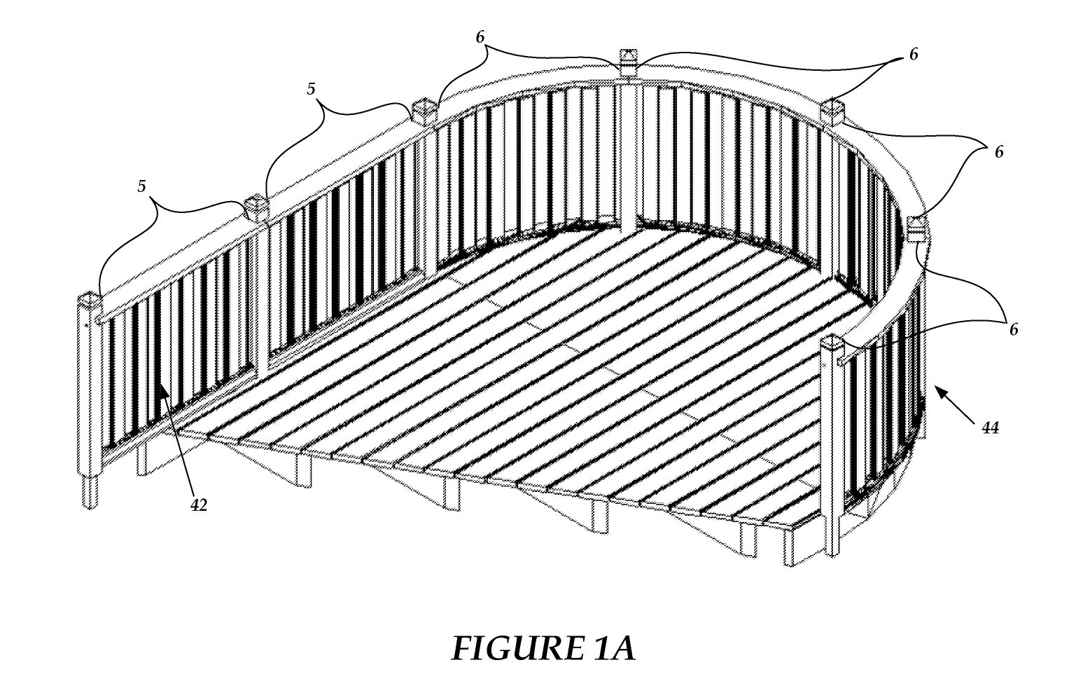

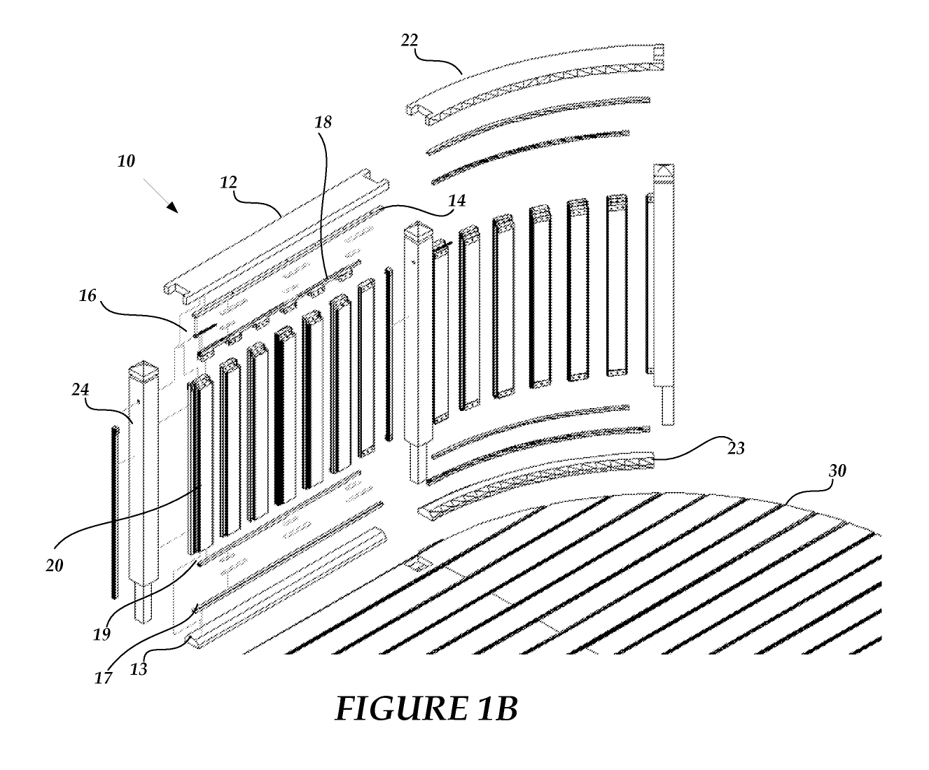

Referring now to the drawings, in which like numerals represent like elements through the several figures, various aspects of the present invention will be described. FIG. 1A is a perspective view is a perspective view of a deck incorporating a slide-glide panel privacy system, in accordance with an embodiment. The deck includes separate straight slide-glide panel sections (or barrier panels) 5 and curvilinear slide-glide panel sections (or barrier panels) 6. It should be understood that each of the individual panel sections 5 and 6 may operate independently or in concert with each other and may further be operated either manually or with automation (i.e., automatically).

FIG. 1B is a partially exploded view of a deck railing 10 and a deck 30 incorporating the system, in accordance with an embodiment. The deck railing 10 may be comprised of one or more posts 24, straight top rail 12, curvilinear top rail 22, straight bottom rail 13, curvilinear bottom rail 23 and multiple sets of opposing balusters 20 and 28 which integrally utilize upper and lower slide-glides. As should be understood by those skilled in the art, the balusters 20 and 28 may comprise vertical members which tie together the top and bottom rails 12, 13, 22 and 23 and which form open sections in the deck railing 10. It should be understood however, that in accordance with alternative embodiments, the deck railing 10 may be tied together with a solid material such as mesh, glass, metal, wood, composites, etc. It should further be understood that, in accordance with various embodiments, the deck railing 10 may comprise one or more sections which may include one or more straight sections, one or more curvilinear barrier sections or a combination of both straight and curvilinear sections.

The system may comprise an upper channel 14, a control screw 16, the balusters 28 (which utilize integral slide-glides), a lower channel 18, an upper bottom channel 19 and a lower bottom channel 17, which are integrally positioned directly above and below the balusters 20. As will be described in greater detail below, the system may be utilized to cover existing spaces or gaps between stationary balusters comprising a deck railing in order to provide privacy as desired and as defined by a user's discretion.

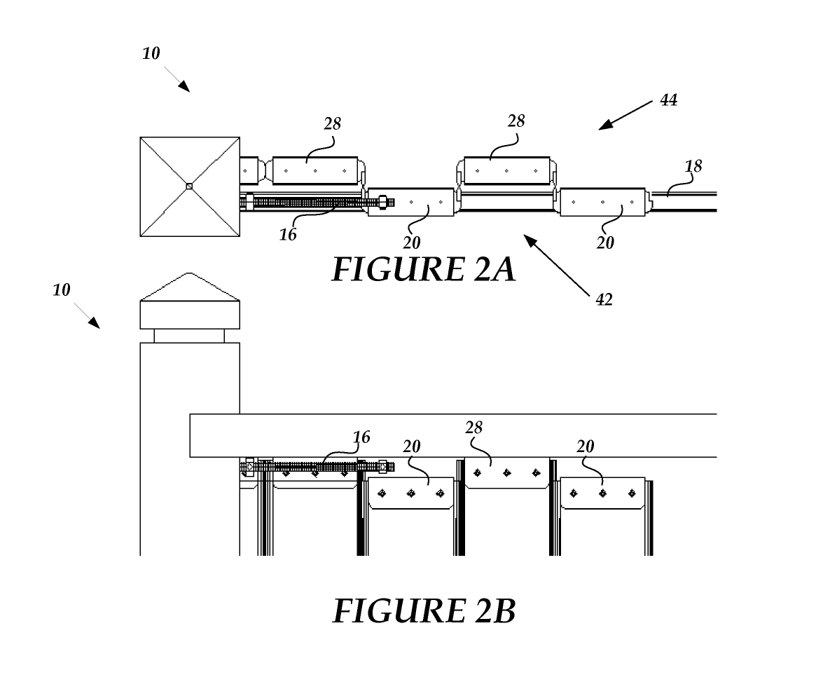

FIG. 2A is a top view of the system in a closed orientation, in the deck railing 10, in accordance with an embodiment. As shown in FIG. 2A, the balusters 20 in the deck railing 10 have been moved from their previous positions opposite the stationary balusters 28 to close the gaps or spaces between the balusters. As will be described in greater detail herein, the control screw 16 may be actuated (by either manual or automated means) to slide the balusters 20 in the lower channel 18 until they are seated in the gaps or spaces between the stationary balusters 28. In particular, the control screw 16 may be rotated in a first direction (i.e., a counter-clockwise direction) to push the balusters 20 from their initial position opposing the stationary balusters 28 to their final position over the gaps or spaces in the deck railing 10.

It should be understood that the system described in the aforementioned embodiment may utilize a number of different means of sliding movement and also utilize various track system configurations. In accordance with an embodiment, the system may utilize a combination of wheels, bearings, hangers (such as those used in garage door systems in which the door hangs on a shaft having wheels) and pin-shafts which travel on and in-between the upper and lower channels 14 and 18. In accordance with another embodiment, the system may utilize a combination of opposing magnets which travel on and in-between the upper and lower channels 14 and 18. It should be appreciated that the use of the opposing magnets facilitates a frictionless or nearly frictionless slide movement of the system from an open state or multiple user-defined semi-closed configurations. Other combinations may also be utilized.

FIG. 2B is a front view of the system in a closed orientation, in the deck railing 10, in accordance with an embodiment. As shown in FIG. 2B, the balusters 20 in the deck railing 10 have been moved, via the rotation of the control screw 16, from their previous positions opposite the stationary balusters 28 to close the gaps or spaces between the balusters. It should be understood that the balusters 20 may be shorter than the stationary balusters 28 to facilitate the sliding of the balusters 20 in the upper channel 14.

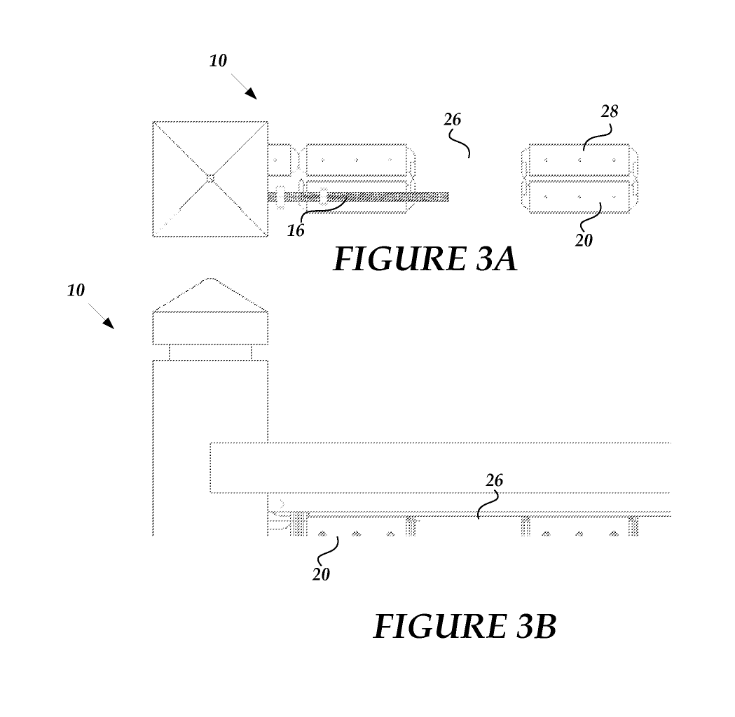

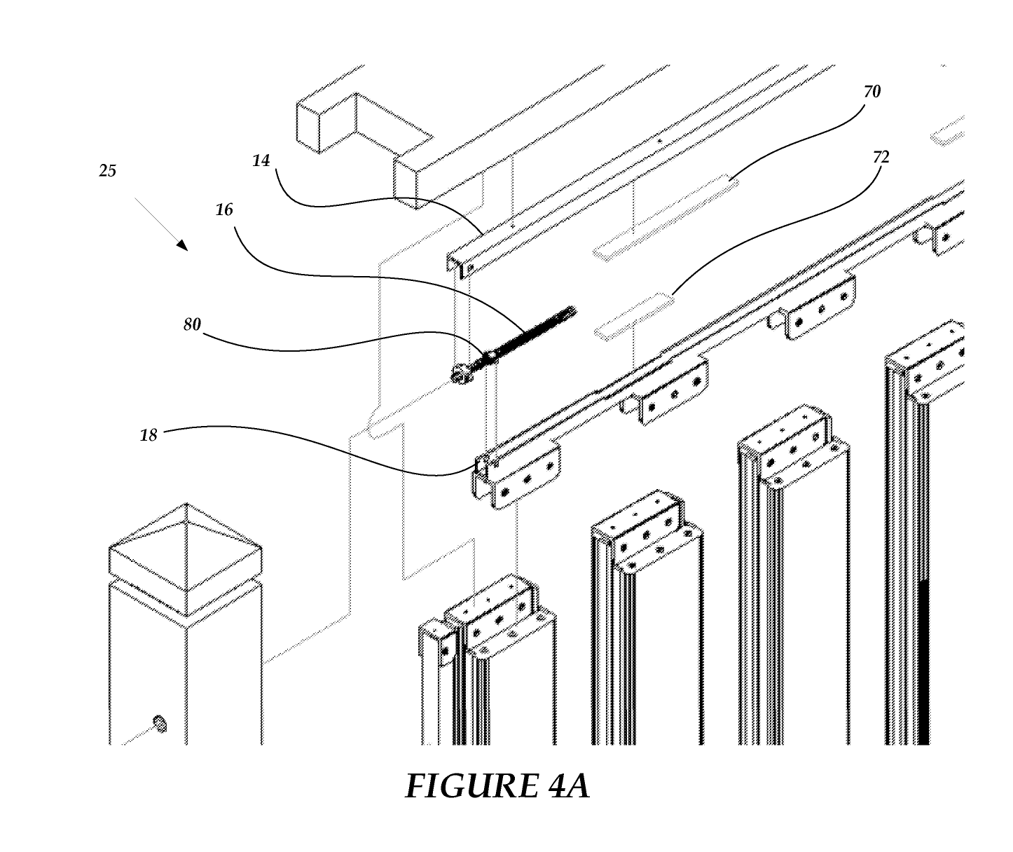

FIG. 3A is a top view of the system in an open orientation, in the deck railing 10, in accordance with an embodiment. As shown in FIG. 3A, the balusters 20 in the deck railing 10 are oriented opposite the stationary balusters 28 thereby forming gaps or spaces between the balusters in the deck railing 10. As will be described in greater detail herein, the control screw 16 may be actuated (by either manual or automated means) to slide the balusters 20 in the lower channel 18 until they are oriented opposite the stationary balusters 28. In particular, the control screw 16 may be rotated in a second direction (i.e., a clockwise direction) to pull the balusters 20 from a closed orientation, in which the balusters 20 fill the gaps or spaces in the deck railing 10, to an open orientation opposite the stationary balusters 28.

FIG. 3B is a front view of the system in a closed orientation, in the deck railing 10, in accordance with an embodiment. As shown in FIG. 3B, the balusters 20 in the deck railing 10 are oriented opposite the stationary balusters 28, thereby forming gaps or spaces between the balusters in the deck railing 10.

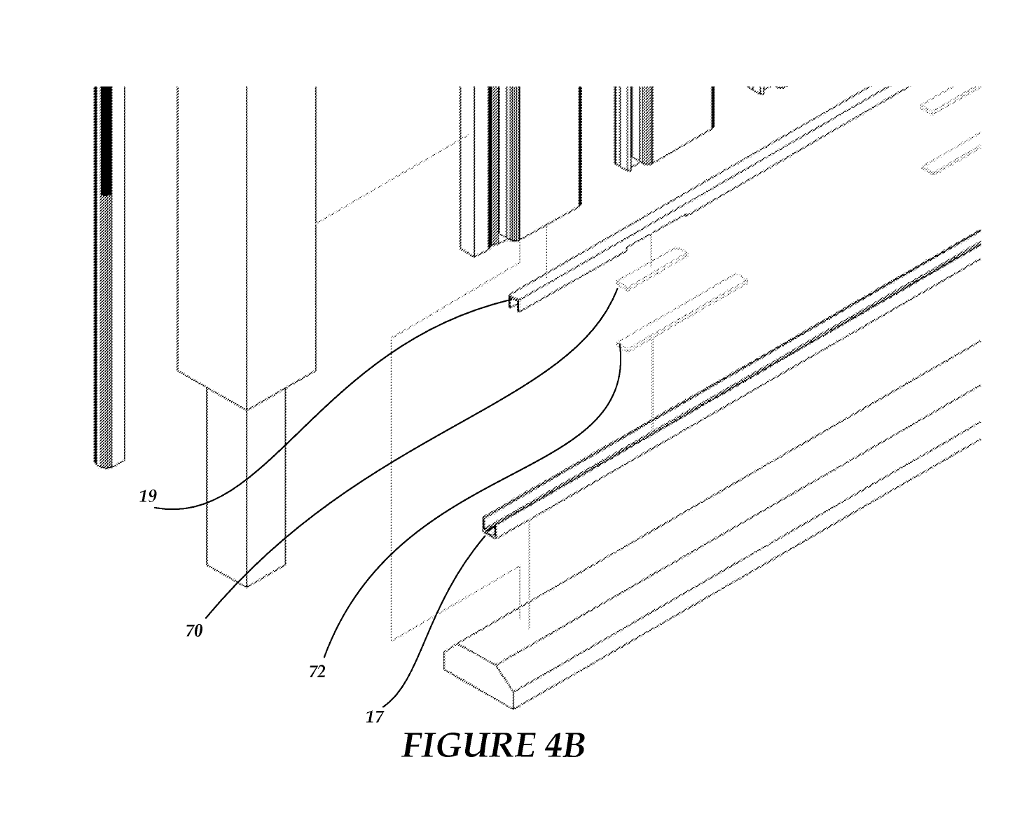

FIG. 4A is an exploded view of illustrative components utilized in a mode of operation of the system, in accordance with an embodiment. In FIG. 4A, the components of a system 25 may include the upper channel 14, the control screw 16 and the lower channel 18. The control screw 16 may comprise an engaging nut 80 which may be utilized to engage openings in the lower channel 18 for pushing or pulling (depending on the direction of rotation of the control screw 16) balusters or panels of a deck railing barrier section. The system of FIG. 4A also includes two opposing magnets 70 and 72. As discussed above, the opposing magnets may be utilized for travel on and in-between the upper and lower channels 14 and 18. It should be appreciated that the use of the opposing magnets facilitates a frictionless or nearly frictionless slide movement of the system from an open state or multiple user-defined semi-closed configurations.

FIG. 4B is an exploded view of a bottom magnet configuration for the system of FIG. 4A, in accordance with an embodiment. As shown in FIG. 4B, the opposing magnets 70 and 72 may be positioned between the upper and lower bottom channels 19 and 17. As discussed above, the opposing magnets may be utilized for travel on and in-between the upper and lower bottom channels 19 and 17. It should be appreciated that the use of the opposing magnets facilitates a frictionless or nearly frictionless slide movement of the system from an open state or multiple user-defined semi-closed configurations.

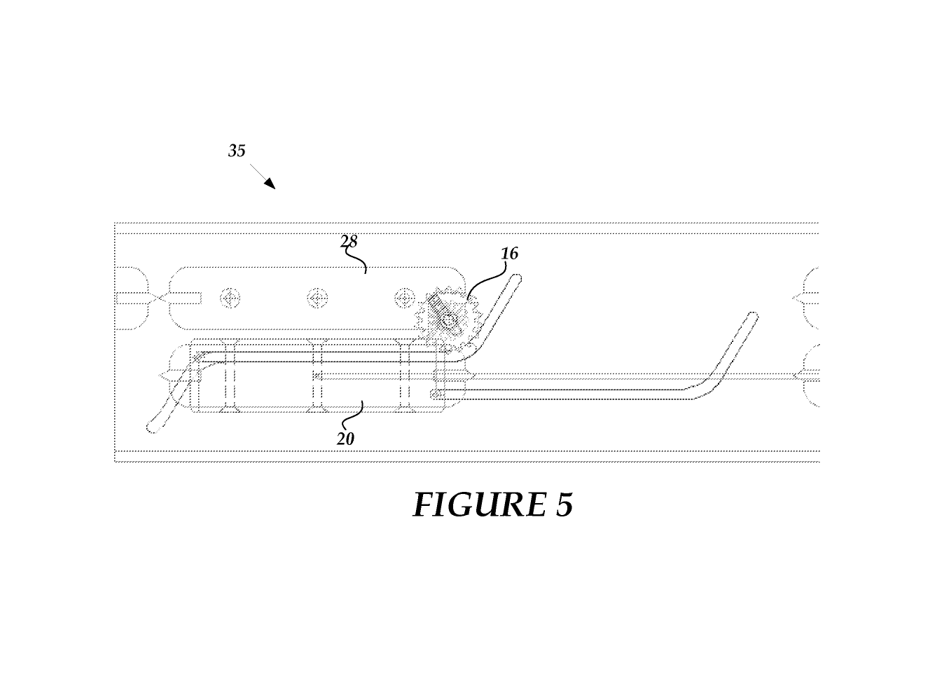

FIG. 5 is a top view of the system in an open orientation, in accordance with an alternative embodiment. In FIG. 5, a system 35 is shown in which a rotating gear mechanism 16 may be utilized (instead of the control screw 16) for sliding the balusters 20 against the stationary balusters 28 to open spaces or gaps in a deck railing.

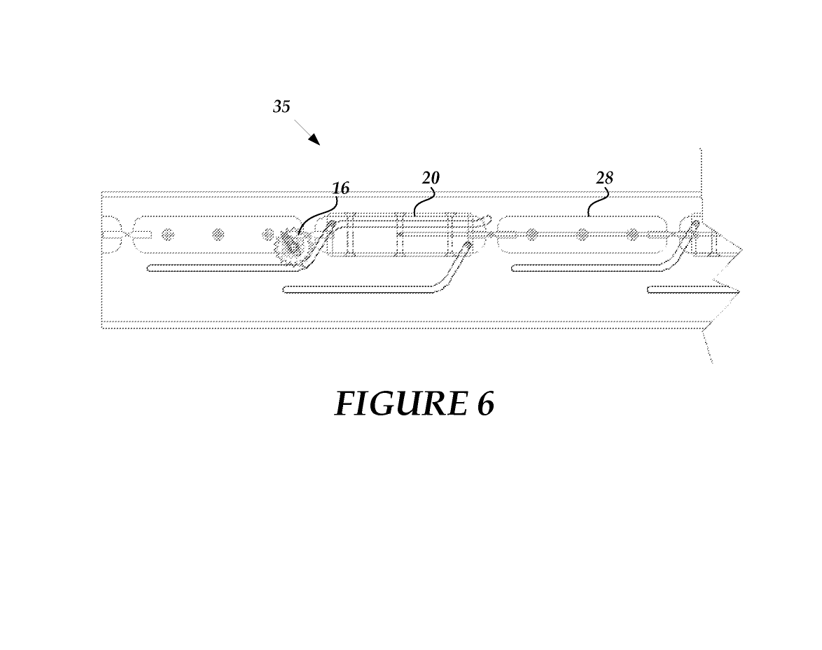

FIG. 6 is a top view of the system in a closed orientation, in accordance with an alternative embodiment. In FIG. 6, the system 35 is shown in which the rotating gear mechanism 16 may be utilized (instead of the control screw 16) for sliding the balusters 20 against the stationary balusters 28 to close spaces or gaps in a deck railing.

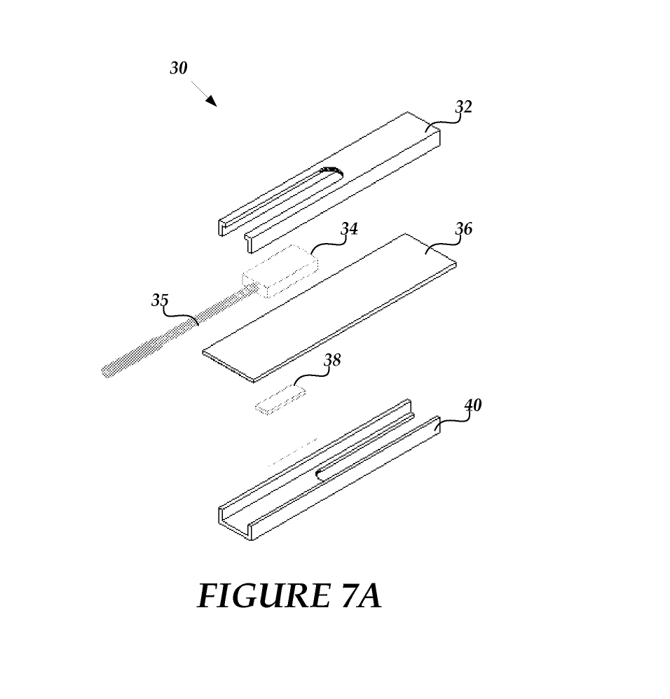

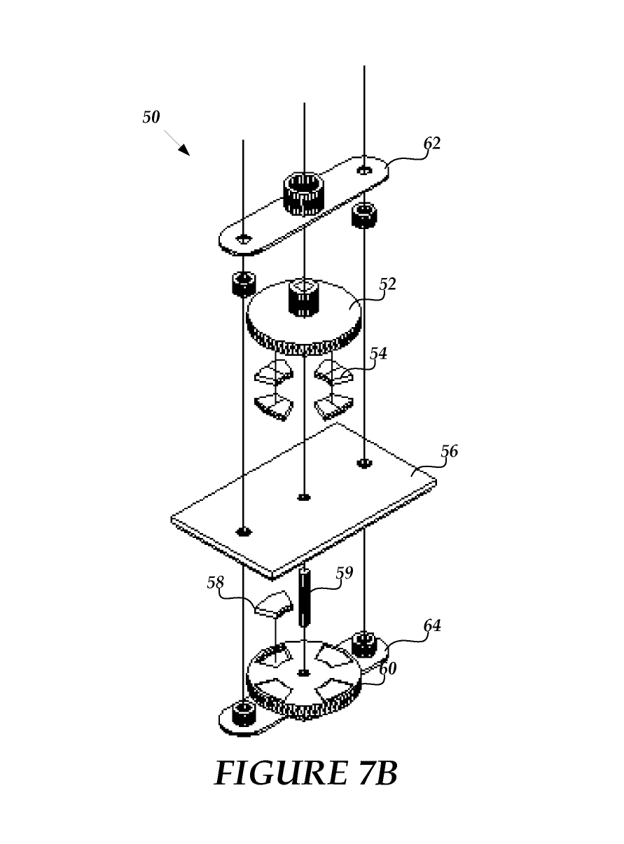

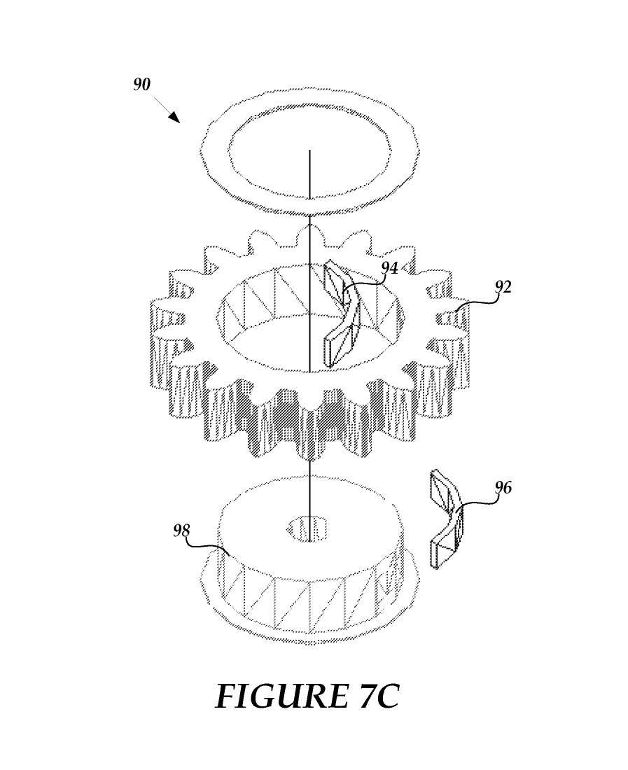

FIG. 7A is an exploded view of a bar safety slip mechanism 30 which may be utilized in the system, in accordance with an embodiment. The bar safety slip mechanism 30 may include an upper non-magnetic housing 32, a first magnet 34, a shaft 35, a second magnet 38 and a lower non-magnetic housing 40. In accordance with an embodiment, the first and second magnets 34 and 38 have opposing polarities (i.e., one positive, one negative). It should be understood that the bar safety slip mechanism 30 may function as a magnetic decoupler in which the opposing magnets 34 and 38 attract each other inside of the upper and lower non-magnetic housings 32 and 40. The shaft 35 may be utilized to fasten to sections (e.g., balusters) of a deck railing or fence as well as to a manual or automated power source for opening and closing the aforementioned sections. In accordance with an alternative embodiment, one of the non-magnetic housings 32 or 40 may be molded into the balusters of a deck railing. It should be appreciated that the bar safety slip mechanism 30 may be utilized to decouple opening or closing of the balusters of a deck railing (such as when a person inadvertently slips their extremities (e.g., fingers) between the balusters) such that the movement of the balusters would stop thereby avoiding the pinching of the person's extremities between the balusters.

FIG. 7B is an exploded view of a cylindrical safety slip mechanism 50 which may be utilized in the system, in accordance with an embodiment. The cylindrical safety slip mechanism 50 may include an upper non-magnetic housing 52, a first set of magnets 54, a non-magnetic separator 56, a second set of magnets 58, a shaft 59, a lower magnetic housing 60, and upper and lower fastening members 62 and 64. In accordance with an embodiment, the first and second sets of magnets 54 and 58 have opposing polarities (i.e., positive and negative). It should be understood that the cylindrical safety slip mechanism 50 may function as a magnetic decoupler in which the opposing magnet sets 54 and 58 attract each other inside of the upper and lower non-magnetic housings 52 and 60. It should be appreciated that the cylindrical safety slip mechanism 50 may be utilized to decouple opening or closing of the balusters of a deck railing (such as when a person inadvertently slips their extremities between the balusters) such that the movement of the balusters would stop thereby avoiding the pinching of the person's extremities between the balusters.

FIG. 7C is an exploded view of a cylindrical safety slip mechanism 90 which may be utilized in the system, in accordance with another embodiment. The cylindrical safety slip mechanism 90 may include an upper housing 92, a lower housing 98, and opposing magnets 94 and 96. In accordance with an embodiment, the magnets 94 and 96 have opposing polarities (i.e., positive and negative). It should be understood that the cylindrical safety slip mechanism 90 may function as a magnetic decoupler in which the opposing magnets 94 and 96 attract each other inside of the upper and lower housings 92 and 98. It should be appreciated that the cylindrical safety slip mechanism 90 may be utilized to decouple opening or closing of the balusters of a deck railing (such as when a person inadvertently slips their extremities between the balusters) such that the movement of the balusters would stop thereby avoiding the pinching of the person's extremities between the balusters.

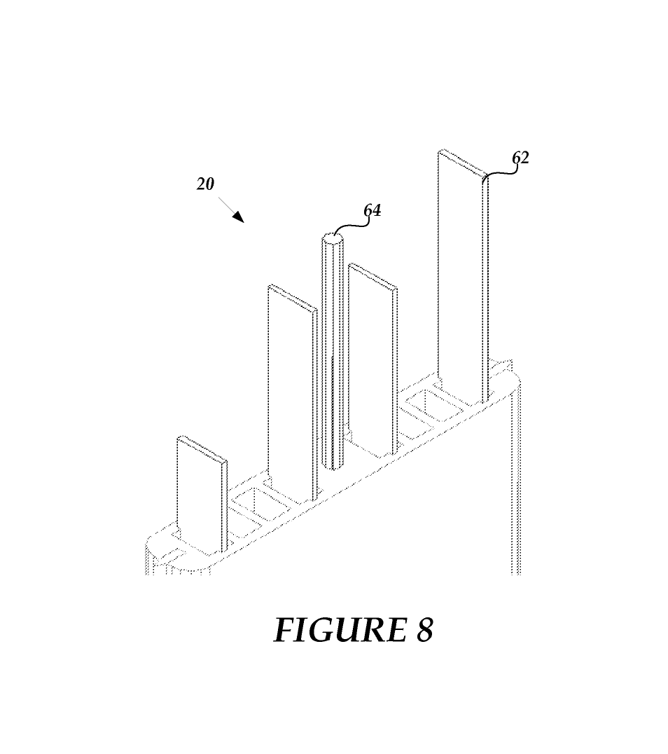

FIG. 8 is a perspective view of lateral reinforced inserts 62 and 64 for balusters (e.g., a baluster 20) utilized in the system, in accordance with an embodiment. In particular, a baluster 20 may be manufactured out of composite, polyvinyl chloride (“PVC”) or an extruded-type of material with hollowed-out sections or voids for receiving the lateral reinforced inserts 62 and 64. It should be understood that the lateral reinforced inserts 62 and 64 may be constructed of a metal material and may be utilized in composite and PVC balusters as well as balusters made of an extruded-type material because balusters constructed of the aforementioned materials are typically laterally weaker than alternative baluster construction materials such as wood or metal.

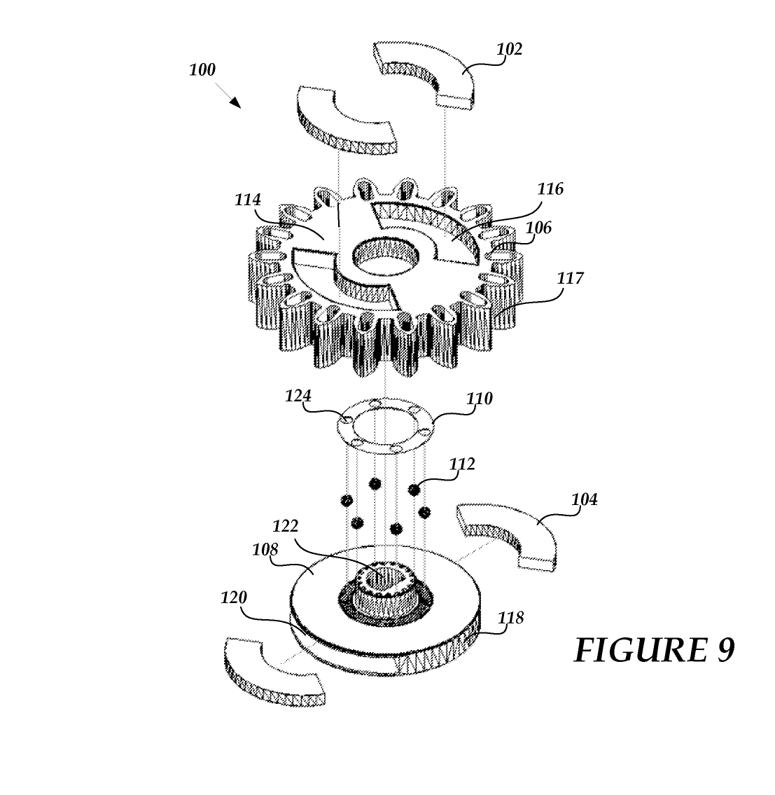

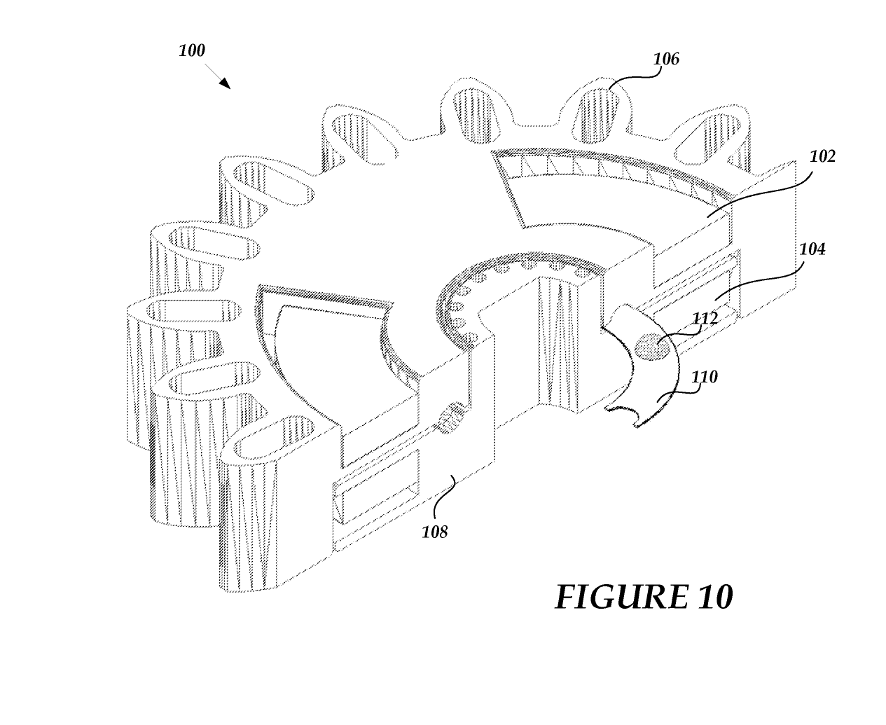

FIGS. 9-10 illustrate a further example cylindrical safety slip mechanism 100 which may be utilized in the system. In particular, FIG. 9 is an exploded view of a further example cylindrical safety slip mechanism 100, and FIG. 10 is a side cross-sectional view of the cylindrical safety slip mechanism 100 of FIG. 9. In some embodiments, the cylindrical safety slip mechanism 100 includes a first set of magnets 102, a second set of magnets 104, an upper housing 106, a lower housing 108, a bearing ring plate 110, and one or more ball bearings 112.

In this example, the first set of magnets 102 and the second set of magnets 104 have opposite polarities (i.e., positive and negative). As discussed below, the opposing magnet sets 102 and 104 attract each other inside of the upper and lower housings 106 and 108, and thus operate the safety slip mechanism 100 as a magnetic decoupler, which decouples opening or closing of the balusters of a deck railing (such as when a person inadvertently slips their extremities between the balusters) such that the movement of the balusters would stop thereby avoiding the pinching of the person's extremities between the balusters.

The upper housing 106 is configured to receive, and mount, the first set of magnets 102 on a top surface 114 of the upper housing 106. In some embodiments, the upper housing 106 includes recesses 116 configured to receive the first set of magnets 102. The upper housing 106 has a bottom surface that is opposite to the top surface of the upper housing 106. The bottom surface is configured to engage the lower housing 108, as shown in FIG. 10. In some embodiments, the upper housing 106 includes a threaded portion 117 configured to engage a control mechanism, such as the control screw 16, of the deck system. In some embodiments, the upper housing 106 is made from non-magnetic materials.

The lower housing 108 is configured to receive, and mount, the second set of magnets 104 on a side surface 118 of the lower housing. In some embodiments, the lower housing 108 includes pockets 120 configured to receive the second set of magnets 104. In some embodiments, the lower housing 108 includes a driving portion 122 configured to engage a drive shaft of a motor so that the safety slip mechanism 110 is operated by the motor. In some embodiments, the lower housing 108 is made from non-magnetic materials.

The bearing ring plate 110 is engaged between the upper housing 106 and the lower housing 108 and operates to allow a smooth rotation of the upper housing 106 relative to the lower housing 108. In some embodiments, the bearing ring plate 110 includes ball support holes 124 configured to rotatably support the ball bearings 112.

The ball bearings 112 are sized to sit on the ball support holes 124 and rotatably engaged between the upper housing 106 and the lower housing 108. The ball bearings 112 operate to roll as the upper housing 106 rotates relative to the lower housing 108.

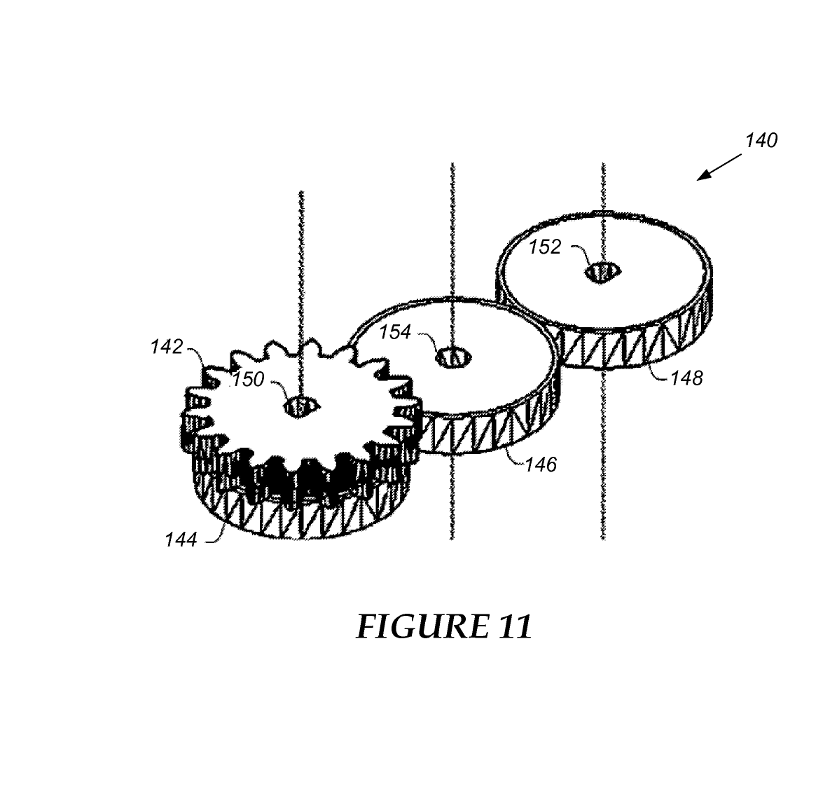

In some embodiments, the cylindrical safety slip mechanisms 50, 90 and 100 are used as the control screw 16 of FIGS. 5 and 6. In other embodiments, the safety slip mechanisms 50, 90 and 100 are utilized in a drive train assembly 140, as shown in FIG. 11.

FIG. 11 illustrates an example drive train assembly 140, utilizing the cylindrical safety slip mechanism 50, 90 or 100. In some embodiments, the cylindrical safety slip mechanism 50, 90 or 100 operates as a drive gear 142 located on the one end of the drive train system 140 and is coupled with a drive wheel 144. This drive wheel 144 is in contact with an idler wheel 146, which is in contact with a drive wheel 148. The drive train system 140 is made of as many drive and idler wheels as there are individually driven balusters. In some embodiments, the drive wheels 144 and 148 include respective oblong holes 150 and 152 to prevent slipping of the wheels on the drive shaft, whereas the idler wheel 146 includes a round hole 154 for free rotation on its shaft.

In some embodiments, the drive train assembly 140 does not include a drive gear 142, but only includes drive wheels 144, 146 and 148. The engaging surfaces of the drive wheels 144, 146 and 148 are made of rubber, which allows the drive wheels 144, 146 and 184 to engage one another by fractional force. These rubber drive wheels 144, 146 and 148 are advantageous in absorbing the shrink or expansion of the drive wheels due to variations in temperature, for example.

In other embodiments, various configurations of a drive train assembly are utilized as necessary. Examples of such configurations of a drive train assembly are disclosed in U.S. Pat. No. 7,673,853, titled Fencing Section with Adjustable Fencing Members, issued on Mar. 9, 2010, the disclosure of which is hereby incorporated by reference in its entirety.

As shown in FIGS. 1A and 2A, the opposing balusters 20 and 28 of the panel sections 5 and 6 are arranged to form a first side 42 and a second side 44. In some embodiments, the first side 42 faces the interior of the deck, and the second side 44 faces the exterior of the deck. By selective operation of the opposing balusters 20 and 28 as described above, the interior of the deck can, or cannot, be seen from the second side 44 (the outside) through the gaps or spaces between the balusters 20 and 28, or the outside of the deck can, or cannot, be seen from the first side 42 (the inside) of the deck through the gaps or spaces formed between the balusters 20 and 28.

Furthermore, as described above, the opposing balusters are separate from other components, such as frame or barrier sections, and operatively connected to the other components. The opposing balusters are not integrated parts of the frame or barrier sections.

Referring back to FIG. 8, the lateral reinforced inserts are configured to reinforce balusters with relatively longer height or length. For example, the lateral reinforced inserts are inserted into the hollowed-out sections or voids of the balusters that have a length or height of more than about two feet, which is required by some building safety codes or regulations.

It will be apparent to those skilled in the art that various modifications or variations may be made without departing from the scope or spirit of the embodiments described herein. Other embodiments will be apparent to those skilled in the art from consideration of the specification and practice of the embodiments described herein.

What is claimed is:

1. A slide-glide panel privacy system for deck railings and fences comprising:
a first stationary panel section comprising a first plurality of balusters;
one or more sliding panel sections positioned in an opposite facing orientation with respect to the first panel section, the one or more sliding panel sections comprising a second plurality of balusters;
an upper railing attached to the first and the one or more sliding panel sections;
a lower railing attached to the first and the one or more sliding panel sections;
at least one post attached to the upper and lower railings; and
a plurality of slide pieces integrally attached to the second plurality of balusters, the plurality of slide pieces facilitating the movement of the one or more sliding panel sections along a sliding path such that the one or more sliding panel sections cover or open an existing space between the first plurality of balusters.

2. The system of claim 1, wherein the sliding path of the one or more sliding panel sections is linear.

3. The system of claim 1, wherein the sliding path of the one or more sliding panel sections is linear is curvilinear.

4. The system of claim 1, wherein the one or more sliding panel sections are constructed from a composite material.

5. The system of claim 1, wherein the one or more sliding panel sections are constructed from wood.

6. The system of claim 1, wherein the one or more sliding panel sections are constructed from metal.

7. The system of claim 1, wherein the one or more sliding panel sections are constructed from a glass.

8. The system of claim 1, wherein the one or more sliding panel sections are constructed from a transparent thermoplastic.

9. The system of claim 1, wherein the movement of the one or more sliding panel sections comprises a manual operation.

10. The system of claim 1, wherein the movement of the one or more sliding panel sections comprises an automatic operation.

11. A blind barrier section system for a deck railing comprising:
a first stationary panel section comprising a first plurality of balusters;
a plurality of sliding panel sections positioned in an opposite facing orientation with respect to the first panel section, each of the plurality of sliding panel sections comprising a second plurality of balusters;
an upper railing attached to the first and the plurality of sliding panel sections;
a lower railing attached to the first and the plurality of sliding panel sections;
a plurality of posts attached to the upper and lower railings; and
a plurality of slide pieces integrally attached to the second plurality of balusters, the plurality of slide pieces facilitating the movement of the plurality of sliding panel sections along a sliding path such that the plurality of sliding panel sections cover or open existing gaps between the first plurality of balusters.

12. The system of claim 11, wherein the movement of the plurality of sliding panel sections comprises a manual operation.

13. The system of claim 11, wherein the movement of the plurality of sliding panel sections comprises an automatic operation.
